(19) United States
(12) Patent Application Publication
(10) Pub. No.: US 2011/0080812 A1
(43) Pub. Date: Apr. 7, 2011

(54) Full choice wake system

(75) Inventors: Ryan Andrew McQuilkin, Ogden, UT (US); Robert Wayne Gardner, Riverdale, UT (US)

(73) Assignees: Ryan Andrew McQuilkin; Robert Wayne Gardner

(21) Appl. No.: 12/572,272

(22) Filed: Oct. 2, 2009

(51) Int. Cl. G04C 21/00

(52) U.S. Cl. 368/250

(57) ABSTRACT

The full choice wake system is an improvement on the standard alarm clock that allows the user to choose from categories of sounds common of man and nature divided into the most comprehensible categories also including incorporated copyrighted material, with the device also allowing the user to choose different selections for different snooze hits, as well as choose the time interval in between.

An improvement on the standard alarm clock, the full choice wake system allows the user to choose from, in addition to common compact disk, external audio devices, and radio, an extremely broad collection of common sounds of man and nature alike, including any incorporated and copyrighted cultural material, all of which are separated into categories most comprehensible whereby one sound is randomly selected to be played for the user upon waking. Further customization on the users part allows for different category selection for different hits of the snooze button, along with timing between snooze hits. For example, this allows the user to select under a ‘scary’ category to be scared awake initially by the sound of the police, a lightning bolt, or a wild dog, and then upon hitting the snooze button and a few minutes later being further awoken by perhaps a ‘peaceful’ categories' ocean waves, and then one minute later awoken a third time by the spoken word quote of the users favorite preacher, teacher, or cultural figure. It should be noted the many ways to construct this tree of sounds, however the innovation in itself is the element concerned. This specifically requires the user to be able to select categories within categories to whichever extent is necessary.

### CROSS REFERENCE

Not necessary

### FEDERALLY SPONSORED

No.

### BACKGROUND OF THE INVENTION

The Full Choice Wake System's background is simply an improvement on the clock radio, dividing the potential sea of things to be awoken by into understandable and navigable categories.

### BRIEF SUMMARY

The full choice wake system is an improvement on the standard alarm clock that allows the user to choose from categories of sounds common of man and nature divided into the most comprehensible system of categories within categories including incorporated and copyrighted cultural material, with a further feature that the selection of different categories for different snooze hits as well as the time interval are in the users control.

### DETAILED SUMMARY

An improvement on the standard alarm clock, the full choice wake system allows the user to choose from, in addition to common compact disk, external audio devices, and radio, an extremely broad collection of common sounds of man and nature alike, including any incorporated and copyrighted cultural material, all of which are separated into categories most comprehensible whereby one sound is randomly selected to be played for the user upon waking. Further customization on the users part allows for different category selection for different hits of the snooze button, along with timing between snooze hits. For example, this allows the user to select under a ‘scary’ category to be scared awake initially by the sound of the police, a lightning bolt, or a wild dog, and then upon hitting the snooze button and a few minutes later being further awoken by perhaps a ‘peaceful’ categories' ocean waves, and then one minute later awoken a third time by the spoken word quote of the users favorite preacher, teacher, or cultural figure. It should be noted the many ways to construct this tree of sounds, however the innovation in itself is the element concerned. This specifically requires the user to be able to select categories within categories to whichever extent is necessary.

1. The full choice wake system, as an improvement on the clock radio, offers a categorical tree of sounds common to man and nature alike divided into the most comprehensible categories for the user to select from, with categories within categories to whichever extent necessary, also including incorporated copyrighted material.

2. The full choice wake system allows the user to make different selections for different snooze hits, and furthermore customize the time in between snooze alarms.
